(19) United States
(12) Patent Application Publication
(10) Pub. No.: US 2005/0129346 A1
(43) Pub. Date: Jun. 16, 2005

(54) Dynamic polarization mode dispersion emulator

(75) Inventors: Liang Chen, Gloucester (CA); Xiaoyi Bao, Gloucestet (CA); David Waddy, Ottawa (CA)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: University of Ottawa, Ottawa, ON (CA)

(21) Appl. No.: 10/507,571

(22) PCT Filed: Mar. 13, 2003
(86) PCT No.: PCT/CA03/00343

Related U.S. Application Data
(60) Provisional application No. 60/363,931, filed on Mar. 14, 2002.

(51) Int. Cl. G02B 6/26

(52) U.S. Cl. 385/11; 385/27

(57) ABSTRACT

A polarization mode dispersion emulator randomly varies the birefringence of each wave-plate in a biased manner to track the dynamics of polarization mode dispersion in time and allows for different cable types to be emulated. A Gaussian probability density function is used to create the biased changes. A new wave-plate model is derived to accurately model the birefringence changes of the emulator.

### FIELD OF THE INVENTION

The present invention relates generally to emulators. More particularly, the present invention relates to polarization mode dispersion emulators suitable for testing of optical systems.

### BACKGROUND OF THE INVENTION

Polarization mode dispersion is a non-linear phenomenon that causes optical pulses to broaden, particularly in high-speed optical systems (10 Gb/s and greater). This broadening means that pulses can overlap and cause transmitted information to be lost and system performance to be degraded. This is one of the greatest limitations in designing new high-speed systems.

Fiber can be field-tested for polarization mode dispersion to determine, how it will degrade system performance. However, field fiber polarization mode dispersion characterization is a time-consuming and expensive undertaking.

Emulation of polarization mode dispersion permits the behaviour of an optical field fiber to be recreated in a lab setting, thus permitting inexpensive lab testing of high-speed optical systems and polarization mode dispersion compensators. Many groups have demonstrated polarization mode dispersion emulators. These emulators rely on randomly varying the polarization state of light launched into polarizing maintaining fiber sections or birefringent crystals. However, polarization mode dispersion changes dynamically due to environmental and other conditions, resulting in state of polarization and differential group delay fluctuations in the time domain, and conventional polarization mode dispersion emulators do not take into account the true dynamic nature of polarization mode dispersion.

It is, therefore, desirable to provide a polarization mode dispersion emulator that can dynamically emulate polarization mode dispersion and facilitate more accurate and realistic test results.

### SUMMARY OF THE INVENTION

It is an object of the present invention to obviate or mitigate at least one disadvantage of previous polarization mode dispersion emulators. In particular, it is an object of the present invention to provide a method for polarization mode dispersion emulation that models its true dynamic behaviour.

In a first aspect, the present invention provides a method of dynamic polarization mode dispersion emulation using an emulator setup having a birefringent section. The birefringent section has a corresponding polarization controller for controlling a polarization state determinant. The method consists of determining a previous polarization state determinant for the birefringent section; and determining an updated polarization state determinant for the birefringent section. The updated polarization state determinant for the birefringent section obeys a statistical probability distribution function for the dynamic behaviour of a desired fiber type, taking into account the previous polarization state determinant.

In a presently preferred embodiment, the statistical probability distribution function is a Gaussian probability distribution function, the Gaussian width of which is a user-specified dynamic input value corresponding to the dynamic behaviour of a field fiber, such as an aerial, buried, conduit, or submarine cable. Determining the updated polarization state determinant includes determining an updated differential group delay, or mode coupling angle, for the birefringent section, or more particularly, for wave plates associated with the polarization controller to change the differential group delay, or mode coupling angle, of the birefringent section to the updated differential group delay, or mode coupling angle.

In a further aspect, the present invention provides a polarization mode dispersion emulator for use with the above-described test setup. The emulator consists of a random distribution generator and a signal generator. The random distribution generator determines a random distribution of updated polarization state determinants for the polarization controller based on its current polarization state determinant, and obeying a statistical probability distribution function for the dynamic behaviour of a desired fiber type. The signal generator provides a signal to each polarization controller to effect a change of its polarization state determinant to its respective updated polarization state determinant.

In a presently preferred embodiment, the random distribution generator includes a pseudo-random number generator, and determines a random distribution of differential group delay values, or mode coupling angles, for the birefringent section that obey a Gaussian probability distribution function. The Gaussian width is determined by a user-specified dynamic input value that represents the dynamic behaviour of a field fiber, such as, an aerial, buried, conduit, or submarine cable. The signal generator generates control signals for controlling the birefringence of a plurality of wave plates, such as fiber squeezers, associated with the polarization controller.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is schematic of a polarization mode dispersion emulation test setup and emulator according to the present invention;

FIG. 2 is a flow chart of an embodiment of the emulation method according to the present invention;

FIGS. 3a and 3b are histograms comparing state of polarization fit for model and emulator results for different values of a; and

FIGS. 4a and 4b are Maxwellian fits for classical emulator (a) and emulator and experimental field fiber fit (b).

### DETAILED DESCRIPTION

Generally, the present invention provides a method and system for dynamically emulating polarization mode dispersion to facilitate testing of optical systems, and for modelling desired dynamic effects on polarization mode dispersion. The present invention permits polarization mode dispersion dynamics in aerial and other fiber to be modelled by an emulator controlling a test setup having polarization controllers for modifying the polarization of light launched into birefringent fiber sections. A polarization state determinant, such as differential group delay or mode coupling angle, is modified according to a statistical probability distribution function, such as a Gaussian probability distribution function, to dynamically model polarization mode dispersion. This is in contrast to previously known polarization mode dispersion emulators that randomly modify the polarization state determinants in uniform manner.

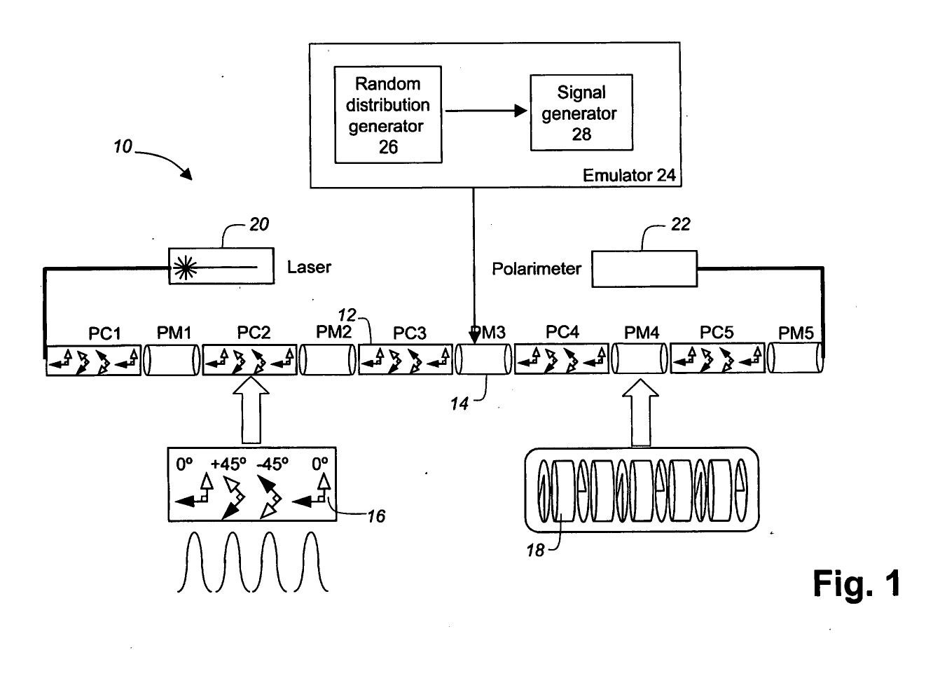

Referring to FIG. 1, the present invention uses a conventional emulation test setup 10 consisting of a number N of polarization controllers 12, each having multiple wave plates. Randomly spliced birefringent, or polarization maintaining fiber, sections 14 are placed after each polarization controller 12, such that the total differential group delay of the system can be changed by varying the birefringence of each wave plate. In the illustrated embodiment, five sets of polarization controllers and polarization maintaining fiber sections are shown. However, as will be understood by those of skill in the art, one or more sets can be used, as deemed appropriate for the desired emulation.

In a presently preferred embodiment, polarization controllers 12 each consist of four piezoelectric squeezers 16 orientated at fixed angles of 0°, +45°, 45° and 0° degrees that squeeze a length of optical fiber thus inducing birefringence, such as commercially available Acrobat™ polarization controllers available from Corning Inc. Each polarization maintaining fiber section 14 consists of a concatenation of birefringent fiber segments 18. A laser source 20 is provided to launch light into the input of the series of polarization controllers 12 and polarization maintaining sections 14, and a polarimeter 22 detects the resulting polarization at the output.

The emulator 24 of the present invention controls the operation of the polarization controllers 12 to modify the total differential group delay of the system 14 by modifying the birefringence of squeezers 16. In operation, the polarization controllers 12 are constructed in such a way that, when certain voltages are applied, the state of polarization of light launched into their respective polarization maintaining fiber sections 14 is modified to an arbitrary point on the Pointcaré sphere. In the presently preferred embodiment, the squeezers 16 in each polarization controller 12 are controlled to randomly change a polarization state determinant of the length of fiber by squeezing the fiber and changing its birefringence. The maximum and minimum applied voltages on each squeezer 16 are calibrated to cause a 0 to 2π rotation of the state of polarization on the Poincaré sphere. The effect of these changes can be modelled by changing the differential group delay of the squeezer 16, which is equivalent to changing the length of the polarization maintaining fiber section 14. The differential group delay of a single polarization maintaining fiber section 14 scales linearly with its length. The squeezers 16 are allowed to randomly tune (squeeze) according to a statistical probability distribution function. This biases the squeezers 16 and models the desired dynamic polarization mode dispersion behaviour. By contrast, a conventional polarization mode dispersion emulator uses an evenly distributed (uniform) probability distribution function.

The emulator 24 generates appropriate control signals based upon the statistical probability distribution function, the current and previous differential group delay, of each polarization controller 12, and a dynamic input value (a that is dependent on the dynamic characteristics of the actual fiber type being emulated. The dynamic input value can be selected by a user, generated by machine or retrieved from a lookup table, or other storage means.

Generally, as shown in FIG. 1, emulator 24 consists of a random distribution generator 26 for determining the random distribution of updated polarization state determinants for each polarization controller 12 based on its current polarization state determinant, and according to a random distribution obeying a statistical probability distribution function for dynamics of a desired fiber type. The emulator 24 also includes a signal generator 28 for generating a signal to the polarization controller 12 to effect a change of its polarization state determinant to its updated polarization state determinant.

In the presently. preferred embodiment of emulator 24, a statistical distribution with memory, analogous to a “random walk” process, is used. This is implemented using a conditional probability distribution function based, for example, on a Gaussian distribution. In this case, the dynamic input value is equivalent to the Gaussian width. It is also filly contemplated that other statistical distributions, such as a Lorentzian distribution, are suitable depending on the data to be modelled, and the present invention is explicitly not limited to a Gaussian probability distribution function. In the presently preferred embodiment, emulator 24 uses a one-generation memory in which a current transition probability is a function only, of the previous value. A variation on this embodiment is to use a statistical distribution with a longer memory in which the current transition probability is a function of more than one previous generation of values.

To model dynamic state of polarization fluctuation for aerial fiber, it is assumed that the polarization controllers cause the differential group delay of each section to take a new value τⱼ (t+Δt) after time increment Δt around its previous position τⱼ (t). A Gaussian function is used because it has been found to accurately describe the random nature of an aerial fiber under expected atmospheric perturbations, such as wind. The Gaussian probability distribution can be described by the following conditional transition probability with periodic boundary condition τⱼ=mod(τⱼ, τ_{j2π})

$$P [ {τ}_{j} ( {t}_{0 +} Δ t ) \vert {π}_{j} ( {t}_{0} ) ] = \frac{1}{σ \sqrt{π}} \cdot {ⅇ}^{\frac{- {[ {τ}_{j} ( t + Δ t ) - {τ}_{j} ( t ) ]}^{2}}{{σ}^{2}}}$$

where σ is the width of the Gaussian probability density function and τ_{j2π} is the value of the differential group delay causing a 2π rotation on a Poincaré sphere.

According to the present invention, to emulate such a model, a pseudo-random number generator is used to generate suitable probability values. A single pseudo-random number generator is sufficient in the present embodiment to generate sufficient pseudo-random numbers to configure each squeezer 16 without significant delay. A Gaussian probability distribution function is used to determine how to change the pressure applied, and hence the differential group delay in the corresponding polarization maintaining fiber section 14, for each of the squeezers 16. Using the described test setup 10, the mode coupling angles for each squeezer 16 axe constant, as determined by the physical makeup of the polarization controllers 12. However, it is fully within the contemplation of the present invention that either the differential group delay or mode coupling angle can be held constant, or that both can be varied, depending on the type of polarization controller chosen for the test setup.

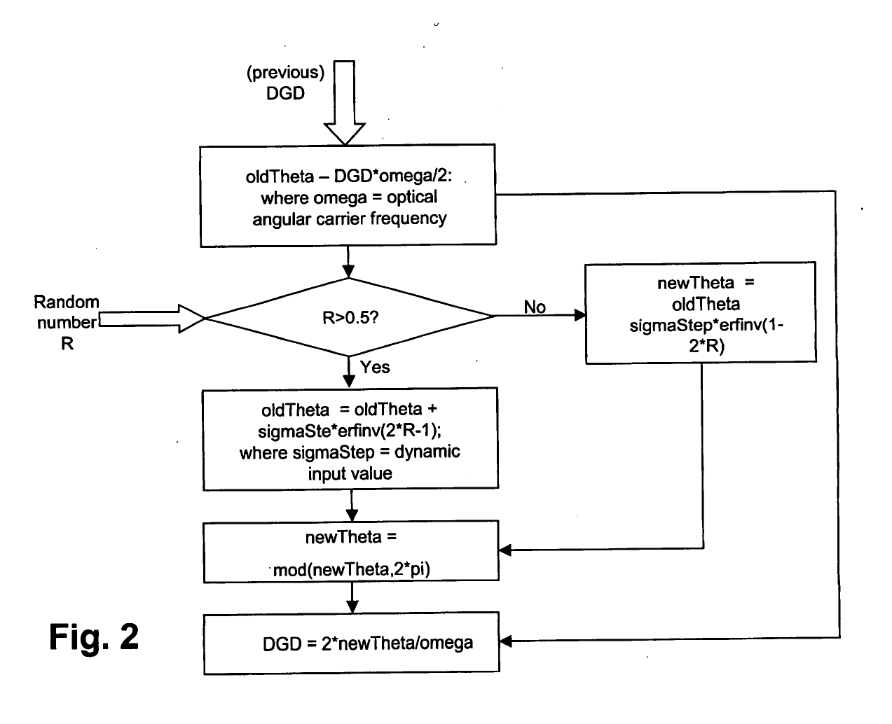

The Matlab™ source code found at Appendix A provides an example implementation of an algorithm according to the present embodiment that creates a distribution of random differential group delay values for generating suitable control signals to control the squeezers 16. The created distribution obeys a particular Gaussian probability distribution function as specified by the dynamic input value (i.e. Gaussian width=“sigmaStep”). A flow chart, corresponding to the example implementation is illustrated in FIG. 2. As shown, the inputs are the current differential group delay “DGD”, the optical angular carrier frequency “Omega”, and a generated random, or pseudo-random, number. It is assumed that the transition has a short memory, i.e. it takes a new value based only on its current value. The time variable is implicit, not explicit. To account for a time evolution of At each of the orientation angles is permitted to update with every realization.

By manipulating the dynamic input value, representing the width of a Gaussian probability distribution function, the emulator of the present invention can be set to emulate the dynamics of different fiber types in varying conditions, for example aerial, buried, conduit, and undersea.

State of polarization and polarization mode dispersion measurements are taken at each time interval Δt. Correlation functions can be used to analyze the emulated state of polarization and polarization mode dispersion measurements. To analyze the state of polarization results, the angle between the Stokes Vectors with fixed separation time can be used:
γ(t₀, t)=arc cos(\vec{S}ₜ₀·\vec{S}ₜ₀₊ₜ)
where \vec{S}ₜ₀ corresponds to a normalized Stokes Vector at time t₀ and \vec{S}ₜ₀₊ₜ refers to the same at time t₀+t from the experimental state of polarization data For a fixed time delay t histograms can be generated.

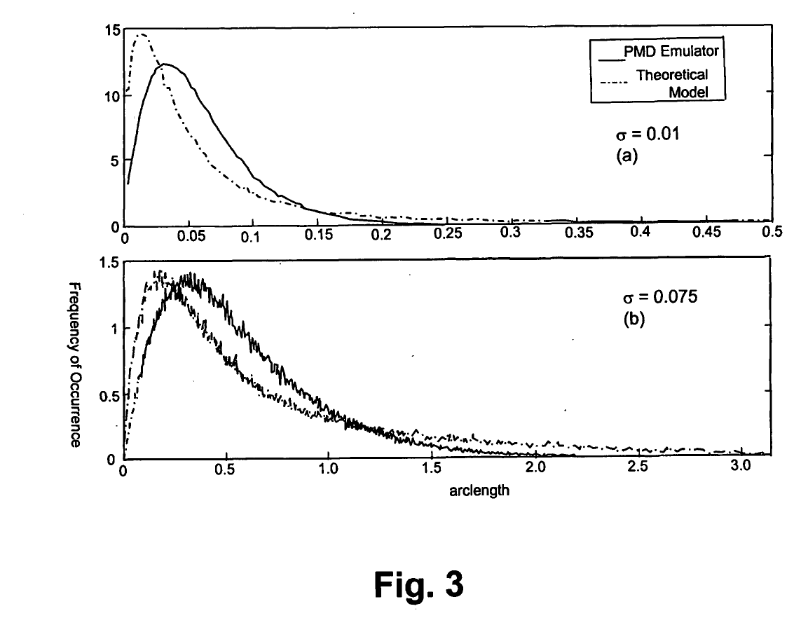

FIGS. 3a and 3b shows state of polarization fits for model and emulator results for σ=0.01 and σ=0.075, which approximate to the dynamics of a buried fiber and a poor aerial fiber, respectively. The fits show high correlation for the buried fiber. The results are more de-correlated for the poor aerial fiber. This is likely due to the use of only five segments in the emulator setup. Increasing the N segments. would improve the correlations.

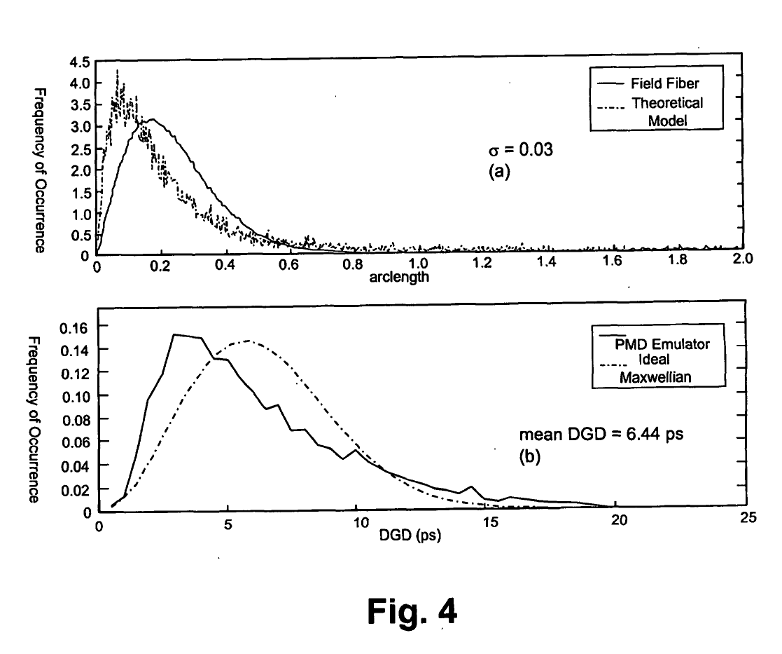

FIGS. 4a shows Maxwellian fits for classical emulator and experimental field fiber fit for an aerial fiber. Arclength curves were generated using the above formula The differential group delay curves shown in FIG. 4b were generated. using a Maxwellian probability distribution function fit and an Aligent Polarimeter.

As will be apparent to those of skill in the art, the present invention accurately emulates dynamic polarization mode dispersion and allows system performance testing in the laboratory without the inconvenience and effort of field tests using real optical fiber. The dynamic polarization mode dispersion emulator can be used by optical systems designers to test systems with differing amounts of dynamic effects, and thus more accurately real world conditions under which different types of fibers operate. This permits more accurate polarization mode dispersion laboratory testing, particularly for high-speed optical systems. It also allows telecommunication companies to investigate the system impact of dynamic polarization mode dispersion. Fiber optic researchers can use the dynamic polarization mode dispersion emulator of the present invention to accurately model polarization mode dispersion in experimental settings.

The above-described embodiments of the present invention are intended to be examples only.. Alterations, modifications and variations may be effected to the particular embodiments by those of skill in the art without departing from the scope of the invention, which is defined solely by the claims appended hereto.

Appendix A:

*****

| | | |
|---|---|---|
| % | inputs: | last DGD = last calculated DGD value |
| % | | sigmaStep = sigma step (const) (GAUSSIAN WIDTH) |
| % | output: | DGD = DGD value |
| % | | |
| % | note: | omega is Gaussian width (angular optical carrier frequency) |
| | | and is a static user input constant. |

oldTheta = ((lastDGD*omega)/2
R = rand(1) %create random value
if(R > 0.5)

newTheta = oldTheta +sigmaStep*erfinv(2*R−1)

else

newTheta = oldTheta − sigmaStep*erfinv(1−2*R)

end

% convert it to always be [0, 2pi]

newTheta = mod(newTheta, 2*pi)

% convert DGD value from [0, 2pi] to a ps DGD value

DGD = 2*newTheta/omega

1. A method of dynamic polarization mode dispersion emulation using an emulator setup having a birefringent, section having a corresponding polarization controller for controlling a polarization state determinant, the method comprising:
(i) determining a previous polarization state determinant for the birefringent section; and
(ii) determining an updated polarization state determinant for the birefringent section in accordance with its current polarization state determinant, the updated polarization state determinant obeying a statistical probability distribution function for dynamics of a desired fiber type.

2. The method of claim 1, wherein determining the updated polarization state determinant includes generating a random sequence.

3. The method of claim 1, wherein the statistical probability distribution function is a Gaussian probability distribution function.

4. The method of claim 3, wherein determining the updated polarization state determinant includes providing a width of the Gaussian probability distribution function.

5. The method of claim 1, wherein determining the updated polarization state determinant includes determining an updated differential group delay.

6. The method of claim 1, wherein determining the updated polarization state determinant includes determining an updated mode coupling angle.

7. The method of claim 5, further including generating control signals to control birefringence of wave plates associated with the polarization controller to change the differential group delay of the bireflingent section to the updated differential group delay.

8. The method of claim 1, wherein determining the updated polarization state determinant includes determining an updated polarization state determinant for a plurality of polarization controllers in turn based on a random sequence.

9. The method of claim 4, wherein the Gaussian width is a dynamic input value corresponding to the dynamic behaviour of a field fiber.

10. The method of claim 9, wherein the field fiber is one of aerial, buried, conduit, and submarine cable.

11. The method of claim 7, wherein the wave plates are fiber squeezers.

12. A polarization mode dispersion emulator for providing a signal to controllers in an emulator setup having a birefringent section having a corresponding polarization controller for controlling a polarization state determinant, comprising:
a random distribution generator for determining a random distribution :of updated polarization state determinants for the polarization controller based on its current polarization state determinant, the random distribution obeying a statistical probability distribution function for dynamics of a desired fiber type;
a signal generator for generating a signal to the polarization controller to effect a change of its polarization state determinant to its updated polarization state determinant.

13. The emulator of claim 12, wherein the random distribution generator includes a pseudo-random number generator.

14. The emulator of claim 12, wherein the random distribution generator determines a random distribution of differential group delay values for the polarization controller.

15. The emulator of claim 12, wherein the generated random distribution obeys a Gaussian probability distribution function.

16. The emulator of claim 15, wherein the Gaussian probability distribution function has a Gaussian width determined by a user-specified dynamic input value.

17. The emulator of claim 16, wherein the dynamic input value represents the dynamic behaviour of a field fiber.

18. The emulator of claim 17, wherein the field fiber is one of aerial, buried, conduit, and submarine cable.

19. The emulator of claim 12, wherein the signal generator generates control signals for controlling the birefringence of a plurality of wave. plates associated with the polarization controller.

20. The emulator of claim. 19, wherein the wave plates are fiber squeezers.
